(19) United States
(12) Patent Application Publication
(10) Pub. No.: US 2021/0362524 A1
(43) Pub. Date: Nov. 25, 2021

(54) ALIGNMENT FEATURES OF ALIGNMENT COVERS

(71) Applicant: HEWLETT-PACKARD DEVELOPMENT COMPANY, L.P., Spring, TX (US)

(72) Inventors: Jeffrey F Bell, Corvallis, OR (US); Kurt F Olsen, Vancouver, WA (US)

(73) Assignee: HEWLETT-PACKARD DEVELOPMENT COMPANY, L.P., Spring, TX (US)

(21) Appl. No.: 16/637,328

(22) PCT Filed: Sep. 22, 2017
(86) PCT No.: PCT/US2017/052948

§ 371 Date: Feb. 7, 2020

(51) Int. Cl. B41J 25/304

(52) U.S. Cl. CPC B41J 25/304

(57) ABSTRACT

In one example in accordance with the present disclosure, an alignment cover for a fluidic ejection device is described. The alignment cover includes a substrate to affix to the fluidic ejection device. At least one alignment feature is disposed on the substrate and mates with corresponding guide features on an alignment post of a carriage. The at least one alignment feature removably couples the fluidic ejection device to the carriage. The alignment cover also includes at least one engagement feature disposed on the substrate. The at least one engagement feature interfaces with the alignment post to reduce relative motion of the fluidic ejection device relative to the carriage.

### BACKGROUND

A fluidic ejection device is a component of a fluid ejection system that is used to eject fluid onto a surface. The fluidic ejection device includes a number of fluid ejecting nozzles. Through these nozzles, fluid, such as ink and fusing agent among others, is ejected or moved. For example, nozzles may include an ejection chamber that holds an amount of fluid and a fluid actuator within the ejection chamber that ejects the fluid through en opening of the nozzle.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a view of an alignment cover for a fluidic ejection device, according to an example of the principles described herein.

FIG. 2 is a view of an alignment post which aligns with the alignment cover for the fluidic ejection device, according to an example of the principles described herein.

FIG. 3 is a top view of the alignment cover for a fluidic ejection device and an alignment post, according to an example of the principles described herein.

FIGS. 4A and 4B are side views of the alignment cover for a fluidic ejection device and an alignment post, according to an example of the principles described herein,

FIGS. 5A and 5B are views of a fluidic ejection device with an alignment cover, according to an example of the principles described herein.

FIG. 6 is a view of a fluidic ejection system with fluidic ejection devices and alignment covers, according to an example of the principles described herein.

FIG. 7 is a simplified top diagram of an additive manufacturing system, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings,

### DETAILED DESCRIPTION

A fluidic ejection device is a component of a fluid ejection system that is used to eject fluid onto a surface. The fluidic ejection device includes a number of fluid ejecting nozzles. Through these nozzles, fluid, such as ink and fusing agent among others is ejected or moved. For example, nozzles may include an ejection chamber that holds an amount of fluid, a fluid actuator within the ejection chamber operates to eject the fluid through an opening of the nozzle.

In a specific example, these fluidic ejection devices are found in any number of printing devices such as inkjet printers, multi-function printers (MFPs), and additive manufacturing apparatuses. The fluidic systems in these devices are used for precisely, and rapidly, dispensing small quantities of fluid. For example, in an additive manufacturing apparatus, the fluidic ejection device dispenses fusing agent. The fusing agent is deposited on a build material, which fusing agent facilitates the hardening of build material to form a three-dimensional product.

Other fluidic, ejection devices dispense ink on a two-dimensional print medium such as paper. For example, during inkjet printing, fluid is directed to a fluidic ejection device. Depending on the content, to be printed, a controller of the fluidic ejection device determines the time and position at which the ink drops are to be released/ejected onto the print medium. In this way, the fluidic ejection device releases multiple irk drops over a predefined area to produce a representation of the image content to be printed. Besides paper, other forms of print media may also be used. Accordingly, as has been described, the systems and methods described herein may be implemented in two-dimensional printing, i.e., depositing fluid on a substrate, and in three-dimensional printing, i.e., depositing a fusing agent or other functional agent on a material base to form a three-dimensional printed product.

While such fluidic ejection devices have increased in efficiency in ejecting various types of fluid, enhancements to their operation can yield increased performance. For example, some fluidic ejection devices are removable from the overall fluidic ejection system in which they are disposed. For example, when a fluidic ejection device is damaged, old, or otherwise inoperable, it may be removed from a fluidic ejection system and replaced with a new fluidic ejection device. Misalignment of the new fluidic ejection device during installation can result in damage to the fluidic ejection device or the system as a whole. For example, fluidic ejection devices may include a needle that punctures a septum of a fluid supply tube. Through this needle/tube interface, fluid is delivered from a reservoir to the fluidic ejection device to be ejected therefrom. Misalignment during installation may result in bending of this needle, even to the point where the needle is broken. Broken needles may result in spillage of the fluid, or inability to pass fluid from the fluid supply tube to the fluidic ejection device. Misalignment may also result in damage to other components. Misalignment can affect other components of the fluidic ejection device and system as well. Such misalignment may result in the unpredictable and undesirable ejection of fluid from the fluidic ejection device, resulting in decreased print quality.

Accordingly, the present specification describes a fluidic ejection device that solves these and other issues. Specifically, the present specification describes an alignment system that includes an alignment cover for a fluidic ejection device. The alignment cover includes alignment features. The alignment cover interfaces with an alignment post that has corresponding guide features. The interface of the guide features and alignment features guide the fluidic ejection device to interface with a positioning datum, which positioning datum places, and maintains, the fluidic ejection device in an operating position during which fluid ejection occurs. Without such an alignment post, a user would attempt to place the fluidic ejection device on the positioning datum without any additional aid. During such an unassisted insertion process, the user may bump the fluidic ejection device into other components, which can damage components of the carriage or the fluidic ejection device itself. Accordingly, the alignment cover and alignment post system allows for guided insertion of the fluidic ejection device until it can interface with the positioning datum of the carriage.

Specifically, the present specification describes an alignment cover for a fluidic ejection device. The cover includes a substrate to affix to the fluidic ejection device. At least one alignment feature is disposed on the substrate. The at least one alignment feature mates with a corresponding guide feature on an alignment post of a carriage. The at least one alignment feature removably couples the fluidic ejection device to the carriage. The cover also includes at least one engagement feature disposed on the substrate. The at least one engagement feature interfaces with the alignment post to reduce relative motion of the fluidic ejection device relative to the carriage.

The present specification also describes a fluidic ejection system. The fluidic ejection system includes a fluidic ejection device that includes a number of fluidic ejection dies. An alignment rover is disposed on the fluidic ejection device and includes at least one alignment feature to mate with a corresponding guide feature on an alignment post of a carriage and to removably couple the fluidic ejection device to the carriage. The cover also includes at least one engagement feature disposed on the substrate. The at least one engagement feature interfaces with the alignment post to reduce relative motion of the fluidic ejection device relative to the carriage. The fluidic ejection system also includes an alignment post that includes at least one guide feature running parallel to a longitudinal axis of the alignment post. The at least one guide feature guides the fluidic ejection device to interface with a positioning datum of the carriage. In this example, the fluidic ejection device slides along the guide features into the interface with the positioning datum.

The present specification also describes a fluidic ejection device. The fluidic ejection device includes a number of fluidic ejection dies disposed on a substrate. Each fluidic ejection die includes an array of nozzles. Each nozzle includes an ejection chamber, an opening, and a fluid actuator disposed within the ejection chamber. Each fluidic ejection device also includes an alignment cover that includes at least one alignment feature to mate with a corresponding guide feature on an alignment post of a carriage. The at least one alignment feature removably couples the fluidic ejection device to the carriage. The cover also includes at least one engagement feature disposed on the substrate. The at least one engagement feature interfaces with the alignment post to reduce relative motion of the fluidic ejection device relative to the carriage.

In summary, using such an alignment cover 1) provides a guided insertion stroke; 2) controls position and orientation of the fluidic ejection device before possible interaction with other components of the carriage; 3) provides sufficient clearance to prevent damage to such components: and 4) can be keyed such that just particular fluidic ejection devices are insertable into the carriage. However it is contemplated that the devices disclosed herein may address other matters and deficiencies in a number of technical areas.

As used in the present specification and in the appended claims, the term “carriage” may refer to various types of carriages including scanning type-carriages and non-scanning type carriages. For example, in a scanning type carriage, the carriage scans across the width of the media, perpendicular to a direction of movement of the media through the printing system. By comparison, in a non-scanning type carriage, the fluidic ejection device may be substrate-wide, meaning the carriage and the fluidic ejection device are stationary while the media moves underneath,

As used in the present specification and in the appended claims, the term “a number of” or similar language is meant to be understood broadly as any positive number including 1 to infinity.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may or may not be included in other examples.

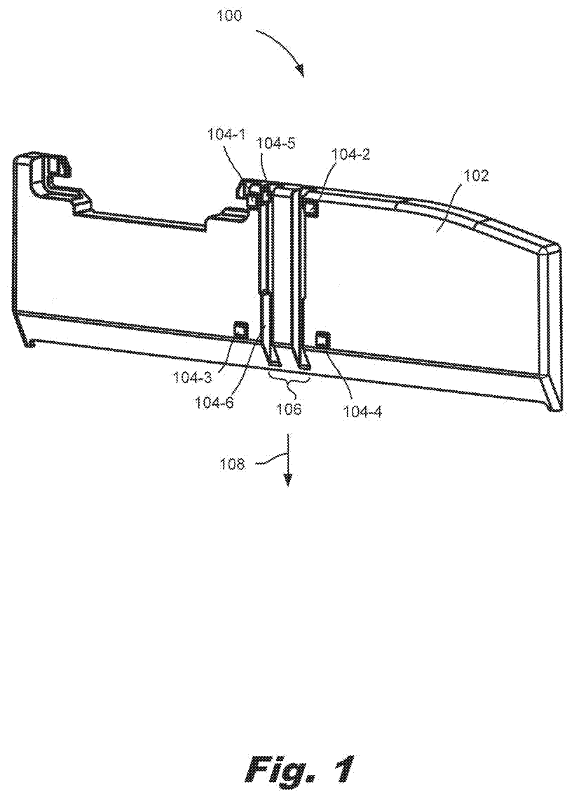

Turning now to the figures, FIG. 1 is a view of an alignment cover (100) for a fluidic ejection device, according to an example of the principles described herein. As described above, a fluidic ejection device refers to a component of a fluidic ejection system used in depositing fluids onto a surface, The fluidic ejection device may be removable from the fluidic ejection system, and therefore can be inserted and removed from the fluidic ejection system. The alignment cover (100) depicted in FIG. 1 allows for the proper orientation and insertion of the fluidic ejection device into the fluidic ejection system.

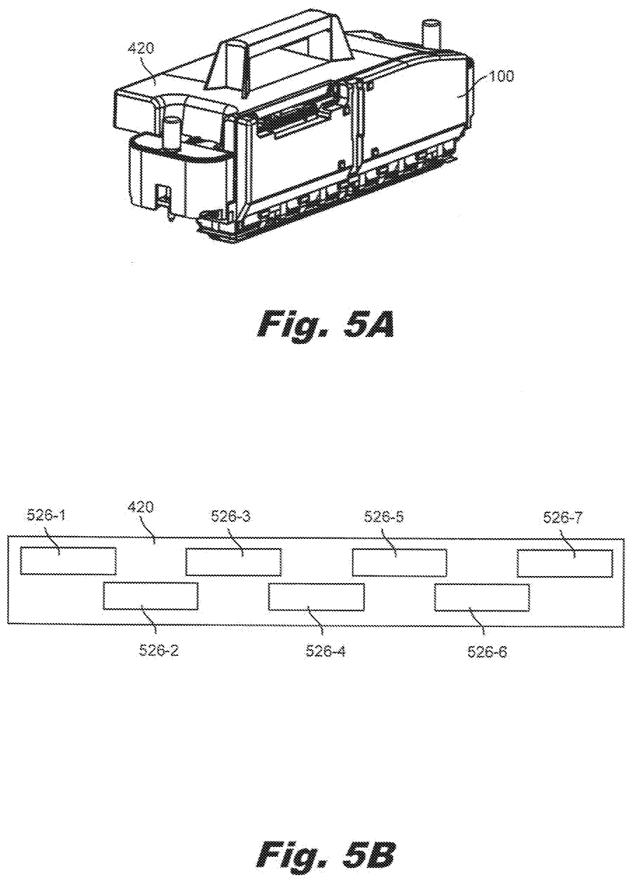

The alignment cover (100) includes a substrate (102) to affix to the fluidic ejection device. The substrate (102) may be formed of any number of materials including plastic. As depicted in FIG. 5, the alignment cover (100) may be affixed to a vertical surface of the fluidic ejection device. The substrate (102) may affix to the fluidic ejection device in any number of ways. For example, mating features, such as mechanical snaps may affix the alignment cover (100) to the fluidic ejection device. Other examples of mechanisms to affix the alignment cover (100) to the fluidic ejection device include screws and adhesives among other affixing mechanisms. In some examples, the alignment cover (100) is integrally formed with a housing of the fluidic ejection device.

Disposed on the substrate (102) is at least one alignment feature (106). The alignment feature (106) mates with a corresponding guide feature on en alignment post to removably couple the fluidic ejection device to a carriage. As a specific example, the alignment feature (106) may be a slot, or a number of slots as depicted in FIG. 1. Upon insertion, these slots interface with corresponding protrusions on the alignment post. That is, a protrusion of the alignment post is inserted into slots on the alignment cover (100) and the fluidic ejection device to which the alignment cover (100) is affixed, is slid down the alignment post. The fluidic ejection device is slid down the alignment post to interface with a positioning datum of the carriage to which the alignment post is coupled. The carriage holds the fluidic ejection device during fluidic ejection and aligns the fluidic ejection device with the surface onto which the fluid is ejected. In some examples, the carriage moves relative to the media and in other examples, the media moves relative to a stationary carriage. While specific reference is made to an alignment cover (100) having slotted alignment features (106) and the alignment post having protrusion guide features, any other type of alignment feature (106) may be used, including a protrusion on the alignment cover (100) and slots on the alignment post.

In some examples, the alignment cover (100) also includes at least one engagement feature (104). For example, the alignment cover may have engagement features (104-1, 104-2, 104-3, 104-4, 104-5, 104-6) disposed on different surfaces of the substrate (102). As one specific example, some of the engagement features (104-5, 104-6) may be disposed within the alignment feature (106), i.e., within the slot. The engagement features (104) interface with the alignment post to reduce relative motion of the fluidic ejection device relative to the carriage. More specifically, the engagement features (104) reduce the movement of the fluidic ejection device during insertion, and then allow greater movement of the fluidic ejection device when the fluidic ejection device is aligned with the positioning datum. For example, during installation, the engagement features (104) prevent movement in ell but an insertion direction a$ indicated by the arrow (108) in. FIG. 1. They may prevent movement by interfacing with different surfaces of the alignment post. For example, the engagement features (104-5, 104-6) within the engagement feature (186) may contact the guide feature of the alignment post and other engagement features (104-1, 104-2, 104-3, 104-4) may contact other surfaces of the alignment post. In combination, the interface of the various engagement features (104) with the alignment post restrict movement in directions other than the insertion direction indicated by the arrow (108).

The engagement features (104) are positioned on the alignment cover (100) such that they disengage from the alignment post when the fluidic ejection device is aligned with the positioning datum of the carriage. That is, the alignment post may have recesses into which the engagement features (104) fail when the fluidic ejection device is aligned with the positioning datum of the carriage. These recesses on the alignment post remove the contact force that previously restricted movement of the fluidic ejection device relative to the carriage. That is, upon disengagement of the engagement features (104) from the alignment post, the fluidic ejection device can move in various directions relative to the carriage as allowed by the positioning datum. For example, the fluidic ejection device can move in six degrees, i.e., an x-direction, a y-direction, a z-direction, a theta-x rotation, a theta-y rotation, and a theta-z rotation relative to the carriage.

Such an alignment cover (100) allows for guided direction of the fluidic, ejection device towards the positioning datum. The positioning datum refers to a component of a fluidic ejection system that precisely aligns the fluidic. ejection device with the carriage. Misalignment of the fluidic ejection device within the carriage may affect operations of the fluidic ejection device and larger fluidic ejection system as well as the preciseness of fluidic ejection, i.e print quality.

The positioning datum is near the bottom surface of the carriage and the alignment cover (100) and alignment post facilitate locating the fluidic ejection device within a gathering region of the positioning datum. That is, the positioning datum has a region wherein if the fluidic ejection device is disposed it can collect, and orient the fluidic ejection device relative to the carriage. However, due to the location of the positioning datum on the carnage it may not be visible during installation of a fluidic ejection device and may be located such that in trying to position the fluidic ejection device within the gathering region, the fluidic, ejection device may contact other components of the carriage. Due to the lack of visual verification and potential undesirable contact the carriage and/or the fluidic ejection device may be damaged. The alignment cover (100), with its alignment and engagement features (106, 104), can alleviate this by providing a guided insertion that 1) directs the fluidic ejection device to the gathering region of the positioning datum and 2) avoids undesirable contact between the carriage and fluidic ejection device.

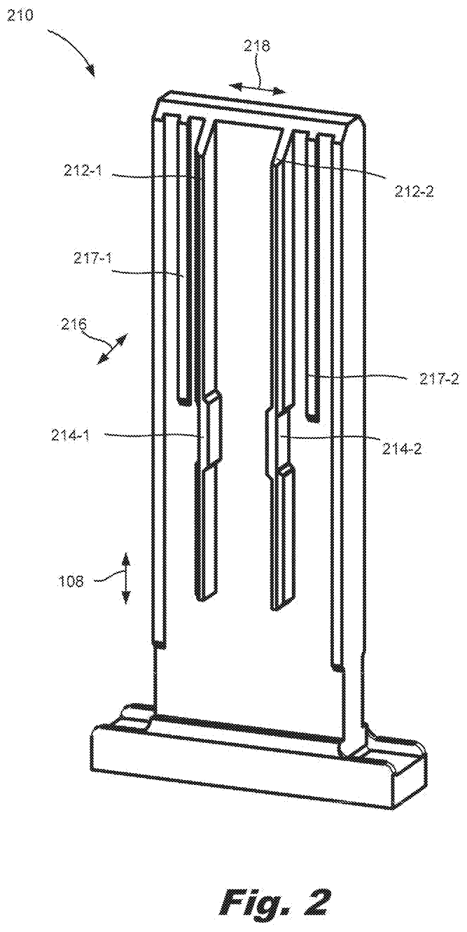

FIG. 2 is a view of an alignment post (210) which aligns with the alignment cover (FIG. 1, 100) for the fluidic ejection device, according to an example of the principles described herein. As described above, the alignment post (210) includes guide features (212-1, 212-2) that guide the fluidic ejection device into position within the carriage. That is, the alignment post (210) may be a component, either mechanically coupled or integrated with, the carriage in which the fluidic ejection device sits during fluidic ejection.

The guide features (212-1, 212-2) may take any form. For example, the guide features (212-1, 212-2) may be protrusions as depicted in FIG. 2. In other examples, the guide features (212-1, 212-2) may be slots into which protrusions on the alignment cover (FIG. 1, 100) sit. Upon insertion, the surfaces of the guide feature (212-1, 212-2) contact the surfaces of the alignment feature (FIG. 1, 106) to guide the fluidic ejection device into place. The engagement features (FIG. 1, 104) of the alignment cover (FIG. 1, 100) also contact the alignment post (210) to restrict motion in the direction indicated by the arrows (216, 218).

The alignment Wast (210) may also include recesses or other surface features that disengage with the alignment cover (FIG. 1, 100) engagement features (FIG. 1, 104) to allow motion. For example, the upper engagement features (FIG. 1, 104-5) of the alignment cover (FIG. 1. 106) disposed within the slot of the alignment cover (FIG. 1 100) upon insertion may be positioned in the recesses (214-1, 214-2) and the lower engagement features (FIG. 1, 104-6) may be below the guide features (212-1, 212-2). As there is no more contact at this point, the alignment cover (FIG. 1, 100) may move in the directions indicated by the arrows (216, 218) as well as the insertion direction (108). Other alignment feature (FIG. 1, 104-1, 104-2, 104-3, 104-4) that are on a surface facing the alignment post (210) may interface with additional surfaces of the alignment post (210), such as the ribs (217-1, 217-2) to prevent motion in the direction indicated by the arrow (216). However, the engagement features (FIG. 1, 104-1, 104-2, 104-3, 104-4) that are on a surface facing the alignment post (210) may be positioned such that they fail below the additional ribs (217) when the fluid ejection device is starting to engage with the positioning datum on the carriage. When below the ribs (217), the motion in the direction indicated by the arrow (216) is now permitted,

Such an alignment post (210) and alignment cover (FIG. 1, 100) system allows for guided insertion of the fluidic ejection device into alignment with a carriage. That is, as noted above, during installation of the fluidic ejection device, motion is prevented in the directions indicated by the arrows (216, 215), but motion is allowed in the direction indicated by the arrow (108). The interface of the alignment feature (FIG. 1, 106), engagement features (FIG. 1, 104), guide features (212) and other surfaces of the alignment post (210) also restrict rotation about any of these directions. Preventing such motion of the fluidic ejection device allows for controlled insertion that prevents undesired contact between the fluidic ejection device and other components of the fluidic ejection system and ensures alignment of the components therein. As depicted in FIG. 2, the guide features (212) of the alignment post (210) may run parallel to a longitudinal axis of the alignment post (210).

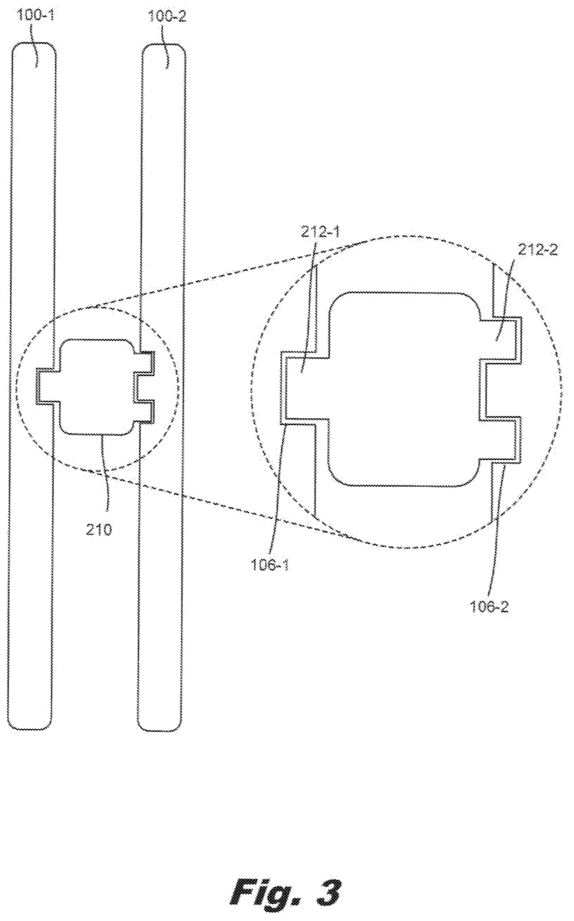

FIG. 3 is a top view of alignment covers (100-1, 100-2) for fluidic ejection devices and an alignment post (210), according to an example of the principles described herein. In some examples, the alignment post (210) may receive multiple alignment covers (100-1, 100-2) each corresponding to a particular fluidic ejection device. That is, as depicted in FIG. 3, the alignment post (210) includes two guide features (212-1, 212-2) disposed on opposite surfaces of the alignment post (210). Each to receive, and guide, a fluidic ejection device to interface with a corresponding positioning datum. For example, the alignment post (210) may receive a first alignment cover (100-1) affixed to a first fluidic ejection device that ejects one color of ink, for example black, ink. The alignment post (210) may receive a second alignment cover (100-2) affixed to a second fluidic ejection device that ejects multiple colors of ink, for example, cyan, magenta, and yellow. Note that as depicted in FIG. 3, in some examples, the alignment features (108-1, 106-2) of the different alignment covers (100-1, 100-2) may be uniquely keyed to mate with guide features (212-1, 212-2) that are unique to a particular type of fluidic ejection device. For example, a monochromatic fluidic ejection device may affix to the first alignment cover (100-1) and may be uniquely interfaceable with the first guide feature (212-1) while being incompatible with the second guide feature (212-2), Similarly, a multi-color fluidic ejection device may affix to the second alignment cover (100-2) and may be uniquely interfaceable with the second guide feature (212-2) while being incompatible with the first guide feature (212-1). Doing so ensures that the proper fluidic ejection device is inserted into the correct position. Incorrect disposition of the fluidic ejection devices within a fluidic ejection system may negatively impact printing, and in some cases may render the fluidic ejection system inoperable, or even damaged.

While FIG. 3 specifically depicts particular keyings, any variety of keyings may be used. For example, interface components may include different numbers and sizes of slots and protrusions, or differently shaped slots and protrusions. For example, the first alignment cover (100-1) may include a triangular-shaped slot and the second alignment cover (100-2) may include a circular-shaped slot to match with corresponding protrusions on the alignment post (210).

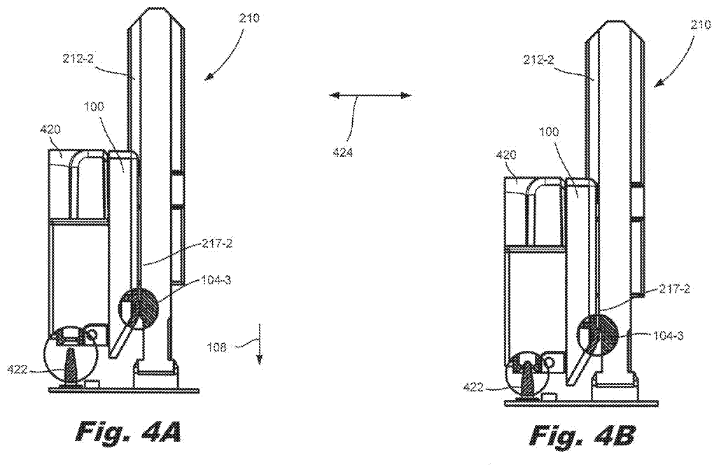

FIGS. 4A and 4B are side views of the alignment cover (100) for a fluidic ejection device (420) and an alignment post (210), according to an example of the principles described herein. Specifically, FIG. 4A depicts the alignment cover (100), fluidic ejection device (420), and alignment post (210) prior to disengagement of the engagement features (FIG. 1, 104) with the alignment post (210) and FIG. 4B depicts the alignment cover (100), fluidic ejection device (420), and alignment post (210) upon disengagement of the engagement features (FIG. 1. 104) with the post (210). Note that FIGS. 4A and 4B depict the engagement/disengagement of a single engagement feature (104-3) with the alignment post (210), but the other engagement features (FIG. 1, 104-1, 104.2, 104-4, 104-5, 104-6) similarly disengage from the alignment post (210) at a same point in the insertion stroke.

As is clearly depicted in FIG. 4A, the alignment cover (100) is affixed to a fluidic ejection device (420) that is used to eject fluid such as ink on a surface such as a powder build material or paper. During installation, the engagement features (FIG. 104), of which one (104-3) is depicted in FIG. 4A, are in contact, or near contact, with the alignment post (210), and more specifically in contact with a rib (217-2) of the alignment post (210). Due to such contact or proximity, motion of the fluidic ejection device (420) in a direction indicated by the arrow (424) is prohibited. Similar contact, or proximity is found between the other engagement features (104-1, 104-2, 104-4, 104-8, 104-6) and the alignment post (210) so as to reduce the movement of the fluidic ejection device (420) with respect to the alignment post (210) and carriage to which the alignment post (210) is coupled. Specifically, in this configuration, the fluidic ejection device (420) and coupled alignment cover (100) may move in a single direction, as indicated by the arrow (108). pow FIG. 4A also depicts the positioning datum (422) of the carriage which, in FIG. 4A is not yet engaged with the fluidic ejection device (420). As described above, the positioning datum (422) is a component of the carriage that precisely aligns the fluidic ejection device (420) with other components of the fluidic ejection system. In some examples, as depicted in FIG. 4A, the positioning datum (422) comprises a protrusion that is received into a hole in the fluidic ejection device (420). The positioning datum (422) in addition to precisely aligning the fluidic ejection device (420), ensures the fluidic ejection device (420) does not move during fluidic ejection. That is, the fluidic ejection system is calibrated based on the position of the fluidic ejection device (420), which calibration determines the precise delivery of fluid out of the fluidic ejection device (420). Accordingly, if the fluidic ejection device (420) were to move relative to the carriage during fluidic; ejection, such calibration would be unreliable such that there would be reduced precision in fluid ejection.

Note that, as depinted in FIGS. 4A and 4B, the engagement features (104) and alignment post (210) are positioned to restrict relative movement of the alignment cover (100) and alignment post (210) prior to engagement of the positioning datum (422) and the fluidic ejection device (420). However, as depicted in FIG. 4B, once the positioning datum (422) interfaces with the fluidic ejection device (420), the alignment features (104), of which one (104-3) is illustrated as an example, is no longer engaging with the alignment post (210), That is, the alignment feature (104-3) has slid past the rib (217-2) and is thereby not restricted to move in the direction indicated by the arrow (424). In this configuration, the fluidic ejection device (420) can now move in the direction indicated by the arrow (424) as dictated by the interface between the fluidic ejection device (420) and the positioning datum (422).

That is, following disengagement of the engagement features (104) and the alignment post (210), the fluidic ejection device (420) has multiple, for example six, degrees of freedom relative to the alignment post (210). The six degrees include an x-direction, a y-direction, a i-direction, rotation about the x-direction, rotation about the y-direction, and rotation about the z-direction. In other words, the fluidic ejection device (420) is to slide along the alignment post (210) into an interface with the positioning datum (422),

FIGS. 4A and 4B also depict that the alignment post (210) is taller, along a longitudinal axis of the alignment post (210), than the fluidic ejection device (420). This ensures that the motion of the fluidic ejection device (420) as it is inserted into position in the carriage, is guided by the alignment post (210) before the fluidic ejection device (420) can interact with other components of the carriage.

FIGS. 5A and 5B are views of a fluidic ejection device (420) with an alignment cover (100), according to an example of the principles described herein. Specifically, FIG. 5B is en isometric view of the fluidic ejection device (420) and FIG. 5B is a bottom view of the fluidic ejection device (420). To eject the fluid onto the surface, the fluidic ejection device (420) includes a number of fluidic ejection dies (526-1, 526-2, 526-3, 526-4, 520-6, 526-6, 526-7) disposed on a substrate. To eject fluid, the fluidic ejection dies (526) include a number of components.

For example, each fluidic ejection die (526) includes an array of nozzles. Each nozzle includes a number of components. For example, a nozzle includes an ejection chamber to hold an amount of fluid to be ejected, an opening through which the amount of fluid is ejected, and an ejecting fluid actuator, disposed within the ejection chamber, to eject the amount of fluid through the opening.

Turning to the ejecting fluid actuators, the ejecting fluid actuator may include a firing resistor or other thermal device, a piezoelectric element, or other mechanism for ejecting fluid from the ejection chamber. For example, the ejecting fluid actuator may be a firing resistor. The firing resistor heats up in response to an applied voltage. As the firing resistor heats up, a portion of the fluid in the ejection chamber vaporizes to form a bubble. This bubble pushes fluid out the opening and onto the print medium. As the vaporized fluid bubble pops, fluid is drawn into the ejection chamber from a passage, and the process repeats. In this example, the fluidic ejection die (526) may be a thermal inkjet (TIJ) fluidic ejection die (526).

In another example, the ejecting fluid actuator may be a piezoelectric device. As a voltage is applied, the piezoelectric device changes shape which generates a pressure pulse in the ejection chamber that pushes the fluid out the opening and onto the print medium. In this example, the fluidic ejection die (526) may be a piezoelectric inkjet (PIJ) fluidic ejection die (526).

The fluidic ejection dies (526) may be coupled to a controller that controls the fluidic ejection dies (526) in ejecting fluid from the nozzle openings. For example, the controller defines a pattern of ejected fluid drops that form characters, symbols, and/or other graphics or images on the print medium. The pattern of ejected fluid drops is determined by the print job commends and/or command parameters received from a computing device.

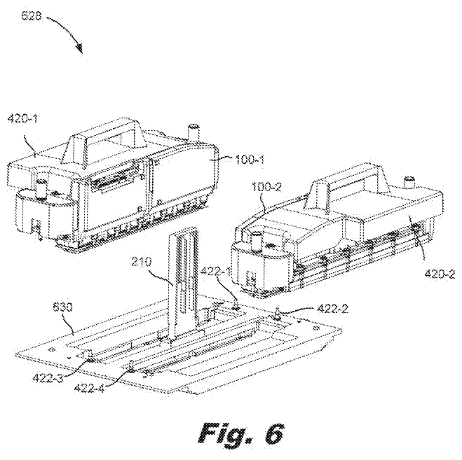

FIG. 6 is a view of a fluidic ejection system (626) with fluidic ejection devices (420) and alignment covers (100), according town example of the principles described herein. The system (628) includes a fluidic ejection device (420) and in some cases multiple fluidic ejection devices (420-1, 420-2). The different fluidic ejection devices (420) may carry out different functions. For example, the first fluidic device (420-1) may be a monochromatic fluid ejection device (420) that ejects fluid of a single color. By comparison, the second fluidic device (420-2) may be a poly-chromatic fluid ejection device (420) that ejects multiple fluids, each having a different color.

In some examples, the fluidic ejection device (420) is a substrate-wide printer and the array of fluidic ejection dies (FIG. 5, 526) are staggered across a width of a substrate on which the fluid is to be deposited. In some examples, the fluid may be ink. In one specific example, the ink may be a water-based ultraviolet (UV) ink, pharmaceutical fluid, or 3D printing material, among other fluids.

Each fluidic ejection device (420) includes an alignment cover (100) that may be uniquely keyed to fit on the alignment post (210) or on a particular location on the alignment post (210). As described above, the guide features (FIG. 2, 212) on the alignment post (210) guide each fluidic ejection device (420) to interface with a positioning datum (420). For example, when the alignment post (210) includes two guide features (FIG. 2, 212) that are disposed on opposite surfaces of the alignment post (210) as indicated in FIG. 6, each guide feature (FIG. 2, 212) is to receive, and guide a fluidic ejection device (420-1, 420-2) onto respective positioning datums (422-1, 422-2, 422-3, 422-4). FIG. 6 also depicts the carriage (630) on which the alignment post (210) and positioning datums (422) are positioned. As described above, the carriage (630) may be a scanning type carriage indicating the carriage (630) may move relative to a surface on which the fluid is to be deposited. In other examples, the carriage (830) may be non-scanning, indicating the carriage (630) does not move relative to the surface and that the surface, such as a print media, moves. In this example, the carriage (630) and fluidic ejection devices (420) may he substrate-wide.

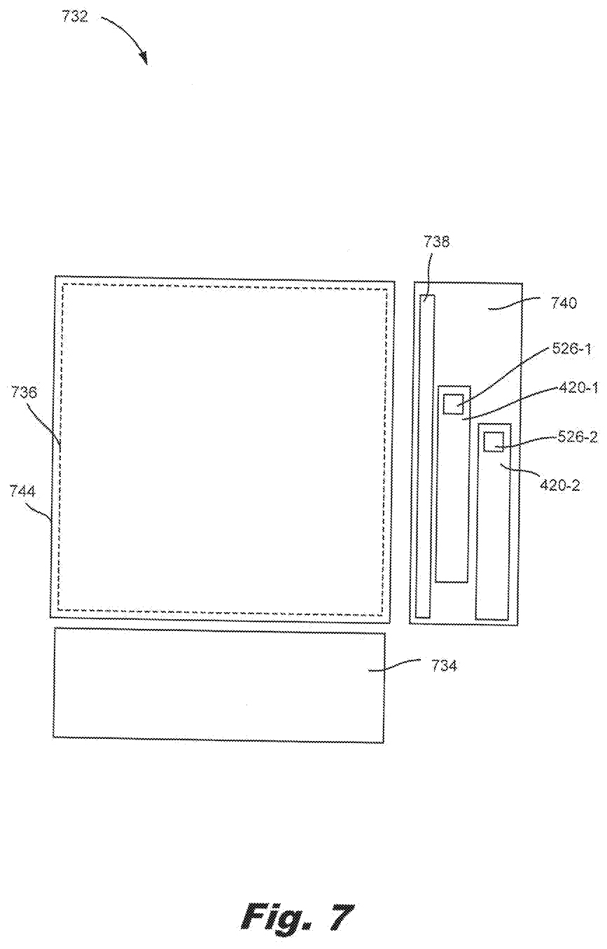

FIG. 7 is a simplified top diagram of an additive manufacturing system (732), according to an example of the principles described herein. Additive manufacturing systems (732) make a three-dimensional (3D) object through the solidification of layers of a build material on a bed within the device. The additive manufacturing system (732) can make objects based on data in a 3D model of the object generated, for example, with a computer-aided drafting (CAD) computer program product. The model data is processed into slices, each slice defining a layer of build material that is to be solidified.

One specific example of an additive manufacturing process is a thermal fusing process, in a thermal fusing process to form the 3D object, a build material, which may be powder or a powder-like material, is deposited on a bed (744). A fusing agent is then dispensed onto portions of the layer of build material that are to be fused to form a layer of the 3D object. The fusing agent disposed in the desired pattern increases the absorption of the underlying layer of build material on which the agent is disposed. The build material is then exposed to energy such as electromagnetic radiation. The electromagnetic radiation may include infrared light or other suitable electromagnetic radiation. Due to the increased heat absorption properties imparted by the fusing agent, those portions of the build material that have the fusing agent disposed thereon heat to a temperature greater than the fusing temperature for the build material.

As energy is applied to a surface of the build material, the build material that has received the fusing agent and therefore has increased energy absorption characteristics, heats up, melts, and fuses while that portion of the build material that has not received the fusing agent remains in powder form. By comparison, the applied heat is not so great so as to increase the heat of the portions of the build material that are free of the fusing agent to this fusing temperature. This process is repeated in a layer-wise fashion to generate a 3D object. The unfused portions of material can then be separated from the fused portions, and the unfused portions recycled for subsequent 3D printing operations.

In examples described herein, a build material may include a powder-based build material, where the powder-based build material may include wet and/or dry powder-basted materials, particulate materials, and/or granular materials. In some examples, the build material may be a weak light absorbing polymer. In some examples, the build material may be a thermoplastic. Furthermore, as described herein, the functional agent may include liquids that may facilitate fusing of build material when energy is applied. The fusing agent may be a light absorbing liquid, an infrared or near infrared absorbing liquid, such as a pigment colorant.

The additive manufacturing system (732) includes a build material distributor (734) to successively deposit layers of the build material in the build area (736). The build material distributor (734) may include a wiper blade, a teller, and/or a spray mechanism. The build material distributor (734) may be coupled to a scanning carnage. In operation, the build material distributor (734) places build material in the build area (736) as the scanning carriage moves over the build area (736) along the scanning axis. While FIG. 7 depicts the build material distributor (734) as being orthogonal to the agent distributor (740), in some examples the build material distributor (734) may be in line with the agent distributor (740).

The additive manufacturing apparatus (732) includes at least one agent distributor (740). An agent distributor (740) includes at least one fluidic ejection device (420-1, 420-2) to distribute a functional agent onto the layers of build material.

One specific example of a functional agent is a fusing agent, which increases the energy absorption of portions of the build material that receive the fusing agent. In some examples the agent distributor (734) is coupled to a scanning carriage, and the scanning carriage moves along a scanning axis over the build area (736). In one example, fluidic ejection devices (420) are used in inkjet printing devices may be used in an agent distributor (740). In this example, the fusing agent may be an ink-type formulation. In other examples, an agent distributor (740) may include other types of fluidic ejection devices (420) that selectively eject small volumes of liquid.

The agent distributor (740) includes at least one fluidic ejection device (420) that has a plurality of fluidic ejection dies (526) arranged generally end-to-end along a width of the agent distributor (740). In such examples, the width of the agent distributor (740) corresponds to a dimension of the bed (744). The agent distributor (740) selectively distributes an agent on a build layer in the build area (736) concurrent with movement of the scanning carriage over the build area (736).

The additive manufacturing system (732) also includes at least one heater (738) to selectively fuse portions of the build material to form an object via the application of heat to the build material. A heater (738) may be any component that applies thermal energy. Examples of heaters (738) include infrared lamps, visible halogen lamps, resistive heaters, light emitting diodes LEDs, and lasers. As described above, build material may include a fusible build material that fuses together once a fusing temperature is reached. Accordingly, the heater (738) may apply thermal energy to the build material so as to heat portions of the build materiel past this fusing temperature. Those portions that are heated past the fusing temperature have a fusing agent disposed thereon and are formed in the pattern of the 3D object to be printed. The fusing agent increases the absorption rate of that portion of the build material. Thus, a heater (738) may apply an amount of energy such that those portions with an increased absorption rate reach a temperature greater than the fusing temperature while those portions that do not have the increased absorption rate to not reach a temperature greater than the fusing temperature. While specific reference is made to deposition of a fusing agent, an additive manufacturing system (732) as described herein may apply any number of other functional agents.

In summary, using such an alignment cover 1) provides a guided insertion stroke; 2) controls position and orientation of the fluidic ejection device before possible interaction with other components of the carriage; 3) provides sufficient clearance to prevent damage to such components; and 4) can be keyed such that just particular fluidic ejection devices are insertable into the carriage. However, it is contemplated that the devices disclosed herein may address other matters and deficiencies in a number of technical areas.

The preceding description has been presented to illustrate and describe examples of the principles described. This description is not intended to be exhaustive or to limit these principles to any precise form disclosed. Many modifications and variations are possible in light of the above teaching.

What is claimed is:

1. An alignment cover for a fluidic ejection device, comprising:
a substrate to affix to the fluidic ejection device:
at least one alignment feature disposed on the substrate to:
mate with corresponding guide features on an alignment post of a carriage; and
removably couple the fluidic ejection device to the carriage; and
at least one engagement feature disposed on the substrate to interface with the alignment post to reduce relative motion of the fluidic ejection device relative to the carriage.

2. The alignment cover of claim 1, wherein the alignment cover is to be coupled to a vertical surface of the fluidic ejection device.

3. The alignment cover of claim 1, wherein the at least one alignment feature is uniquely keyed to mate with a guide feature that is unique to a particular type of fluidic ejection device.

4. The alignment cover of claim 1, wherein the at least one alignment feature is a slot that mates with a protrusion guide feature.

5. The alignment cover of claim 1, wherein upon disengagement of the at least one engagement feature with the alignment post, the fluidic ejection device has greater degrees of freedom as compared to during engagement of the at least one engagement feature with the alignment post.

6. The alignment cover of claim 5, wherein:
during engagement of the at least one engagement feature with the alignment post, the fluidic ejection device has one degree of freedom relative to the carriage; and
following disengagement of the at least one engagement feature from the alignment post, the fluidic ejection device has six degrees of freedom relative to the carriage.

7. The alignment cover of claim 1, wherein at least one of the at least one engagement features is disposed within the at least one alignment feature.

8. A fluidic ejection system, comprising:
a fluidic ejection device comprising a number of fluidic ejection dies;
an alignment cover disposed on the fluidic ejection device comprising;
at least one alignment feature to:
mate with a corresponding guide feature on an alignment post of a carriage: and
removably couple the fluidic ejection device to the carriage; and
at least one engagement feature disposed to interface with the alignment post to reduce relative motion of the fluidic ejection device relative to the carriage; and
the alignment post comprising at least one guide feature running parallel to a longitudinal axis of the alignment post, the at least one guide feature to guide the fluidic ejection device to interface with a positioning datum of the carriage;
wherein the fluidic ejection device is to slide along the guide feature into the interface with the positioning datum.

9. The system of claim 8, wherein;
the at least one guide feature comprises two guide features disposed on opposite surfaces of the alignment post; and
each guide feature is to receive, and guide, a fluidic ejection device to interface with a corresponding positioning datum.

10. The system of claim 9, wherein the two guide features are uniquely keyed to mate with alignment features of different types of fluidic ejection devices.

11. The system of claim 8, further comprising the positioning datum on the carriage to align fluidic ejection dies disposed on the fluidic ejection devices above a substrate on which fluid is to be deposited.

12. The system of claim 8, wherein the alignment post is taller, along the longitudinal axis, than the fluidic, ejection devices.

13. A fluidic ejection device, comprising:
a number of fluidic ejection dies disposed on a substrate, each fluidic ejection die comprising:
an array of nozzles, each nozzle comprising:
an ejection chamber,
an opening; and
a fluid actuator disposed within the ejection chamber;
an alignment cover comprising:
at least one alignment feature to:
mate with a corresponding guide feature on an alignment post of a carriage; and
removably couple the fluidic ejection device to the carriage: and
at least one engagement feature disposed on the substrate to interface with the alignment post to reduce relative motion of the fluidic ejection device relative to the carriage.

14. The fluidic ejection device of claim 13, wherein the alignment cover is to be coupled to a vertical surface of the fluidic ejection device.

15. The fluidic ejection device of claim 13, wherein the fluidic ejection device into slide along the alignment post into an interface with a positioning datum of the carriage.
